(19) United States
(12) Patent Application Publication
(10) Pub. No.: US 2022/0284642 A1
(43) Pub. Date: Sep. 8, 2022

(54) METHOD FOR TRAINING CONVOLUTIONAL NEURAL NETWORK, AND METHOD AND DEVICE FOR STYLIZING VIDEO

(71) Applicant: GUANGDONG OPPO MOBILE TELECOMMUNICATIONS CORP., LTD., Dongguan (CN)

(72) Inventor: Jenhao HSIAO, Palo Alto, CA (US)

(21) Appl. No.: 17/825,312

(22) Filed: May 26, 2022

Related U.S. Application Data
(63) Continuation of application No. PCT/CN2020/131825, filed on Nov. 26, 2020.
(60) Provisional application No. 62/941,071, filed on Nov. 27, 2019.

(51) Int. Cl. G06T 11/00; G06V 10/774; G06V 10/82

(52) U.S. Cl. CPC G06T 11/001; G06V 10/774; G06V 10/82

(57) ABSTRACT

Provided are a method and device for stylizing video as well as a method for training a convolutional neural network (CNN). In the method, each of a plurality of original frames of the video is transformed into a stylized frame by using a first CNN for stylizing; at least one first loss is determined according to a first original frame and second original frame of the plurality of original frames, the second original frame being next to the first original frame; the first CNN is trained according to at least one first loss; and the video is stylized by using the trained first

CNN.

### CROSS-REFERENCE TO RELATED APPLICATION(S)

This application is a continuation of International Application No. PCT/CN2020/131825, filed No. 26, 2020, which claims priority to U.S. Provisional Application No. 62/941,071, filed Nov. 27, 2019, the entire disclosures of which are incorporated herein by reference.

### TECHNICAL FIELD

The present disclosure relates to technical field of imaging processing, and particularly, to a method for training a convolutional neural network (CNN) for stylizing a video, and a method and device for stylizing video.

### BACKGROUND

Style transfer aims to transfer the style of a reference image/video to an input image/video. It is different from color transfer in the sense that it transfers not only colors but also strokes and textures of the reference. Some existing techniques are time consuming and ineffective, while some techniques impose heavy computation burden on computing devices.

### SUMMARY

The embodiments of the present disclosure relate to a method for training a convolutional neural network (CNN) for stylizing a video, and a method and device for stylizing video.

According to a first aspect, there is provided a method for training a convolutional neural network (CNN) for stylizing a video, comprising: transforming each of a plurality of original frames of the video into a stylized frame by using a first CNN for stylizing; determining at least one first loss according to a first original frame and second original frame of the plurality of original frames and results of the transforming, the second original frame being next to the first original frame; and training the first CNN according to the at least one first loss.

According to a second aspect, there is provided a method for stylizing a video, comprising: stylizing a video by using a first convolutional neural network (CNN); where the first CNN has been trained according to at least one first loss which is determined according to a first original frame and second original frame of a plurality of original frames of the video and results of transforming, the second original frame being next to the first original frame, the transforming comprising: transforming each of a plurality of original frames of the video into a stylized frame by using a first CNN for stylizing.

According to a third aspect, there is provided a device for stylizing a video, comprising: a memory for storing instructions; and at least one processor configured to execute the instructions to perform operations of: stylizing a video by using a first convolutional neural network (CNN); where the first CNN has been trained according to at least one first loss which is determined according to a first original frame and second original frame of a plurality of original frames of the video and results of transforming, the second original frame being next to the first original frame, the transforming comprising: transforming each of a plurality of original frames of the video into a stylized frame by using a first CNN for stylizing

### BRIEF DESCRIPTION OF THE DRAWINGS

The accompanying drawings, which are incorporated in and constitute a part of this specification, illustrate embodiments consistent with the present disclosure and, together with the description, serve to explain the principles of the present disclosure.

FIG. 1 illustrates images obtained when the current filters adopted in smartphone perform standard color transformation to the images/videos.

FIG. 2 illustrates stylized frame sequence when video style transfer is performed on original sequence of frames.

FIG. 3 illustrates temporal inconsistency in relevant video style transfer.

FIG. 4 illustrates a flow chart of a method for training a CNN for stylizing a video according to at least some embodiments of the present disclosure.

FIG. 5 illustrates a block diagram of a device for training a CNN for stylizing a video according to at least some embodiments of the present disclosure.

FIG. 6 illustrates a flow chart of a method for stylizing a video according to at least some embodiments of the present disclosure.

FIG. 7 illustrates a block diagram of a device for stylizing a video according to at least some embodiments of the present disclosure.

FIG. 8 illustrates the architecture of the proposed Twin Network according to at least some embodiments of the present disclosure.

FIG. 9 illustrates some example details about the StyleNet according to at least some embodiments of the present disclosure.

FIG. 10 illustrates VGG network which is used as a loss network.

FIG. 11 illustrates style transfer result from the proposed Twin Network according to at least some embodiments of the present disclosure.

FIG. 12 illustrates a block diagram of electronic device according to another exemplary embodiment.

Specific embodiments of the present disclosure have been illustrated through the above accompanying drawings and more detailed descriptions will be made below. These accompanying drawings and textual descriptions are intended not to limit the scope of the concept of the present disclosure in any manner but to explain the concept of the present disclosure to those skilled in the art with reference to specific embodiments.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the present disclosure. Instead, they are merely examples of apparatuses and methods consistent with aspects related to the present disclosure as recited in the appended claims.

Style transfer aims to transfer the style of a reference image/video to an input image/video. It is different from color transfer in the sense that it transfers not only colors but also strokes and textures of the reference.

Gatys et al. (A Neural Algorithm of Artistic Style (Gatys, Ecker, and Bethge; 2015)) presented a technique for learning a style and applying it to other images. Briefly, they use gradient descent from white noise to synthesize an image which matches the content and style of the target and source image respectively. Though impressive stylized results are achieved, Gatys et al.'s method takes quite a long time to infer the stylized image. Afterwards, Johnson et al. (Perceptual Losses for Real-Time Style Transfer and Super-Resolution) use a feed-forward network to reduce the computation time and effectively conduct the image style transfer.

Simply treating each video frame as an independent image, the aforementioned image style transfer methods can be directly extended to videos. However, without considering temporal consistency, those methods will inevitably bring flicker artifacts to generated stylized videos.

Video-based solution tries to achieve video style transfer directly on the video domain. For example, Ruder (and other similar works, for example, Manuel Ruder, Alexey Dosovitskiy, and Thomas Brox titled Artistic style transfer for videos (2016)) presents a method of obtaining stable video by penalizing departures from the optical flow of the input video. Style features remain present from frame to frame, following the movement of elements in the original video. However, the on-the-fly computation of optical flows makes this approach computationally far too heavy for real-time style-transfer, taking minutes per frame.

One of the issues in video style transfer is the temporal inconsistency problem, which can be observed visually as flickering between consecutive frames and inconsistent stylization of moving objects (as illustrated in FIG. 3). In this disclosure, a multi-level temporal loss is introduced according to at least some embodiments of the present disclosure, to stabilize the video style transfer. Comparing to previous method, the proposed method is more advantageous.

First, unlike relevant methods that enforce the temporal consistency at the final output level (e.g., the last network layer), we design a multi-level temporal loss that enforce the high-level semantic information to be synced in earlier network layers, which gives higher flexibility for the network to adjust its weights to achieve the temporal consistency and thus result in better network convergence property. A more stable video style transfer result is also delivered (e.g., without flickering effect).

Second, our method generates no extra computation burden during run time, which may avoid the on-the-fly optical flow calculation and greatly reduce the computation burden.

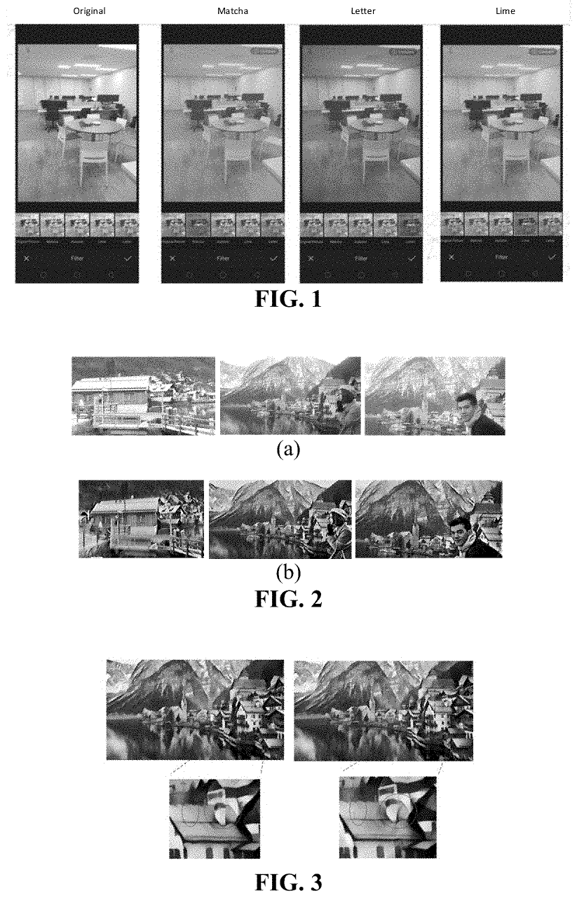

As can be seen in FIG. 1, the current filters adopted in smartphone just perform standard color transformation to the images/videos. These default filters are somewhat boring and can hardly attract users' attention (especially for those young ones).

Style transfer provides a more impressive effect to images and videos, and the number of style filters we can create is unlimited, which can largely enrich the filters in smartphone and is more attractive for (young) users.

As can be seen in FIG. 2, video style transfer transforms the original sequence of frames into another stylized frame sequence. This can provide a more impressive effect to users comparing to relevant filters, which just change the color tone or color distribution. In addition, the number of style filters we can create is unlimited, which can largely enrich the products (such as video album) in smartphone.

In FIG. 2, (a) illustrates an original video and (b) illustrates a stylized video.

Most of the current product adopt an image-based video style transfer method to generate stylized video, where they apply image-based style transfer techniques to a video frame by frame. However, this scheme inevitably brings temporal inconsistencies and thus causes severe flicker artifacts. FIG. 3 illustrates an example of temporal inconsistency in relevant video style transfer. As the highlighted part in the figure, the result of stylized frame t and t+1 is with no temporal consistency and thus create a flickering effect.

FIG. 3 illustrates temporal inconsistency in relevant video style transfer. Left and right images denote the stylized frame at t and t+1 respectively. As can be seen, even under such a short period of time (e.g., 1/30 second), stylized frame t and t+1 is different in several parts (e.g., the parts in the circles) and thus create a flickering effect.

In this disclosure, a temporal stability mechanism, which is generated by Twin Network, is proposed to stabilize the changes in pixel values from frame-to-frame. Furthermore, unlike previous video style transfer methods that introduces heavy computation burden during run time, the stabilization is done at training time, allowing for an unruffled style transfer of videos in real-time.

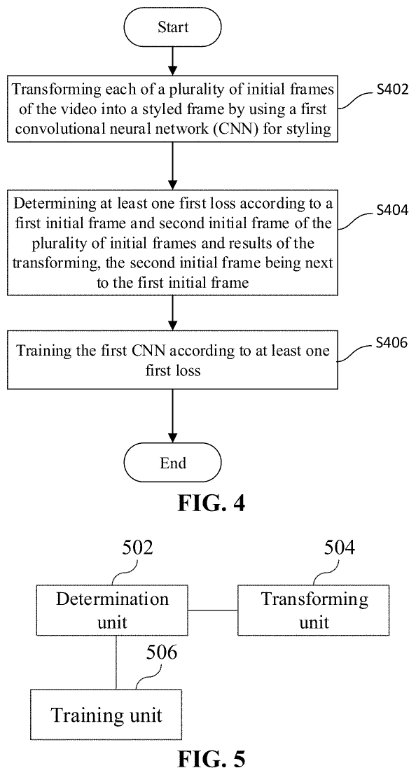

According to a first aspect, there is provided a method for training a CNN for stylizing a video. FIG. 4 illustrates a flow chart of a method for training a CNN for stylizing a video according to at least some embodiments of the present disclosure.

At block S402, each of a plurality of original frames of the video is transformed into a stylized frame by using a first convolutional neural network (CNN) for stylizing.

At block S404, at least one first loss is determined according to a first original frame and second original frame of the plurality of original frames and the results of the transforming. Here, the second original frame is next to the first original frame.

At block S406, the first CNN is trained according to the at least one first loss.

At least one temporal loss is introduced to stabilize the video style transfer, so as to enforce the temporal consistency at the final output level, which will have more flexibility.

In at least some embodiments, the at least one first loss may include a semantic-level temporal loss, and the determining the at least one first loss may include: extracting a first output of a hidden layer in the first CNN when the first CNN is applied to the first original frame, and extracting a second output of the hidden layer in the first CNN when the first CNN is applied to the second original frame; and determining a semantic-level temporal loss according to a first difference between the first output and the second output.

Here, the high-level semantic information is forced to be synced in earlier network layers, it will be easier and effective for adapting the network to a specific type (e.g., in our case, to generate a stable output frames).

Traditional method usually try to enforce the temporal consistency in only the output level (e.g., the last layer of network). However, tuning the result based totally on the output level result is somewhat challenge and has less flexibility to adjust the CNN. Here, the encoder loss is used to alleviate the problem. The encoder loss penalizes temporal inconsistency on the last level feature map to enforce a high-level semantic similarity between two consecutive frames.

In at least some embodiments, the at least one first loss may include a contrastive loss, and the determining the at least one first loss may include: determining a contrastive loss according to a second difference between: (a) a difference between the first original frame and a stylized first frame corresponding to the first original frame, and (b) a difference between the second original frame and a stylized second frame corresponding to the second original frame.

The idea behind contrastive loss is that one should consider the motion changes in the original frames and use them as a guide to update the neural network. For example, if there is a large motion change in the original frames, then we should also expect a relatively large changes between the corresponding stylized frames at time t and t+1. In this case, we should ask the network to output a pair of stylized frames that could be potentially different (instead of blindly enforcing frames t and t+1 to be exactly the same). Otherwise, if only minor or no motion is observed, then the network can generate similar stylized frames.

The contrastive loss can achieves this by trying to minimize the difference between the changes of original and stylized frame at time t and t+1. The information can thus correctly guide the CNN to generate images depending on the source motion changes. In addition, comparing to the direct temporal loss that is difficult to train, the contrastive loss guarantees a more stable neural network training process and a better converge property. One advantage of the contrastive loss is that it introduces no extra computation burden to run time.

In at least some embodiments, the above method may include transforming each of the plurality of original frames of the video by using a second CNN, the second CNN having been trained on an ImageNet dataset; transforming each of a plurality of the stylized frames by using the second CNN; determining at least one second loss according to an output feature vector of each of the plurality of the original frames at a first layer of the second CNN, and an output feature vector of each of the plurality of the stylized frames at a first layer of the second CNN. Here, training the first CNN according to the at least one first loss includes: training the first CNN according to the at least one first loss and the at least one second loss.

In at least some embodiments, the at least one second loss may include a content loss, and the method further includes: extracting a first feature map of an activation of a convolutional layer of the second CNN when the second CNN is applied to each of the plurality of original frames; extracting a second feature map of an activation of a convolutional layer of the second CNN when the second CNN is applied to a stylized frame corresponding to the original frame; and determining the content loss according to Euclidean distance between the first feature map and second feature map.

By using the content loss to train the CNN, it is advantageous that the difference between the original frame and the stylized frame can be minimized.

In at least some embodiments, the at least one second loss may include a style loss, and the method further includes: determining a first Gram matrix according to a first feature map of an activation of a convolutional layer of the second CNN when the second CNN is applied to each of the plurality of original frames; determining a second Gram matrix according to a second feature map of an activation of a convolutional layer of the second CNN when the second CNN is applied to a stylized frame corresponding to the original frame; and determining the style loss according a difference between the first Gram matrix and second Gram matrix.

By using the style loss to train the CNN, it is advantageous that the difference between styles of two frame can be minimized.

In at least some embodiments, determining the style loss according the difference between the first Gram matrix and second Gram matrix includes: determining the style loss according a squared Frobenius norm of the difference between the first Gram matrix and second Gram matrix.

In at least some embodiments, training the first CNN according to the at least one first loss and the at least one second loss includes: training the first CNN such that a weighted sum of the at least one first loss and the at least one second loss is minimized.

In at least some embodiments, training the first CNN such that a weighted sum of the at least one first loss and the at least one second loss is minimized includes: training the first CNN based on a method which uses gradient to update network parameters of the first CNN, such that a weighted sum of the at least one first loss and the at least one second loss is minimized.

In at least some embodiments, the second CNN is selected from a group including a VGG network, InceptionNet, and ResNet.

According to a second aspect, there is provided a device for training a CNN for stylizing a video. FIG. 5 illustrates a block diagram of a device for training a CNN for stylizing a video according to at least some embodiments of the present disclosure.

The device may include a determination unit 502, transforming unit 504 and training unit 506.

The transforming unit 504 is configured to transform each of a plurality of original frames of the video into a stylized frame by using a first convolutional neural network (CNN) for stylizing.

The determination unit 502 is configured to determine at least one first loss according to a first original frame and second original frame of the plurality of original frames and results of the transforming. The second original frame may be next to the first original frame.

The training unit 506 is configured to train the first CNN according to at least one first loss.

In at least some embodiments, the at least one first loss may include a semantic-level temporal loss. The determination unit 502 is configured to extract a first output of a hidden layer in the first CNN when the first CNN is applied to the first original frame, and extracting a second output of the hidden layer in the first CNN when the first CNN is applied to the second original frame; and determining a semantic-level temporal loss according to a first difference between the first output and the second output.

In at least some embodiments, the at least one first loss may include a contrastive loss. The determination unit 502 is configured to determine a contrastive loss according to a second difference between: (a) a difference between the first original frame and a stylized first frame corresponding to the first original frame, and (b) a difference between the second original frame and a stylized second frame corresponding to the second original frame.

In at least some embodiments, the transforming unit 504 is configured to transform each of the plurality of original frames of the video by using a second CNN. The second CNN having been trained on an ImageNet dataset. The transforming unit 504 is configured to transform each of a plurality of the stylized frames by using the second CNN; determining at least one second loss according to an output feature vector of each of the plurality of the original frames at a first layer of the second CNN, and an output feature vector of each of the plurality of the stylized frames at a first layer of the second CNN.

The training unit 506 is configured to train the first CNN according to the at least one first loss and the at least one second loss.

In at least some embodiments, the at least one second loss may include a content loss. The determination unit 502 is further configured to extract a first feature map of an activation of a convolutional layer of the second CNN when the second CNN is applied to each of the plurality of original frames; extract a second feature map of an activation of a convolutional layer of the second CNN when the second CNN is applied to a stylized frame corresponding to the original frame; and determine the content loss according to Euclidean distance between the first feature map and second feature map.

In at least some embodiments, the at least one second loss may include a style loss. The determination unit 502 may be further configured to determine a first Gram matrix according to a first feature map of an activation of a convolutional layer of the second CNN when the second CNN is applied to each of the plurality of original frames; determine a second Gram matrix according to a second feature map of an activation of a convolutional layer of the second CNN when the second CNN is applied to a stylized frame corresponding to the original frame; and determine the style loss according a difference between the first Gram matrix and second Gram matrix.

In at least some embodiments, the determination unit 502 may be configured to determine the style loss according a squared Frobenius norm of the difference between the first Gram matrix and second Gram matrix.

In at least some embodiments, the training unit 506 may be configured to train the first CNN such that a weighted sum of the at least one first loss and the at least one second loss is minimized.

In at least some embodiments, the training unit 506 is configured to train the first CNN based on a method which uses gradient to update network parameters of the first CNN, such that a weighted sum of the at least one first loss and the at least one second loss is minimized.

There is provided a non-transitory storage medium having stored thereon computer-executable instructions that, when being executed by a processor, cause the processor to perform the method as described above.

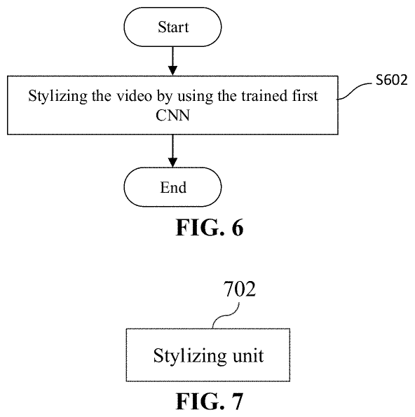

FIG. 6 illustrates a method for stylizing a video according to at least some embodiments of the present disclosure.

At block S602, a video is stylized by using a first convolutional neural network (CNN). Here, the first CNN has been trained according to at least one first loss which is determined according to a first original frame and second original frame of a plurality of original frames of the video and results of transforming, the second original frame being next to the first original frame, the transforming comprising: transforming each of a plurality of original frames of the video into a stylized frame by using a first CNN for stylizing.

According to some embodiments, the at least one first loss may include a semantic-level temporal loss, and the semantic-level temporal loss is determined according to a first difference between the first output and the second output, the first output is an output of a hidden layer in the first CNN when the first CNN is applied to the first original frame, and the second output is an output of the hidden layer in the first CNN when the first CNN is applied to the second original frame.

According to some embodiments, the at least one first loss may include a contrastive loss, and the contrastive loss is determined according to a second difference between: (a) a difference between the first original frame and a stylized first frame corresponding to the first original frame, and (b) a difference between the second original frame and a stylized second frame corresponding to the second original frame.

According to some embodiments, the training the first CNN according to the at least one first loss may include: training the first CNN according to the at least one first loss and the at least one second loss.

Here, the at least one second loss may be obtained by: transforming each of the plurality of original frames of the video by using a second CNN, the second CNN having been trained on an ImageNet dataset; transforming each of a plurality of the stylized frames by using the second CNN; and determining the at least one second loss according to an output feature vector of each of the plurality of the original frames at a first layer of the second CNN, and an output feature vector of each of the plurality of the stylized frames at a first layer of the second CNN.

According to at least some embodiments, the at least one second loss may include a content loss, and the content loss may be obtained by: extracting a first feature map of an activation of a convolutional layer of the second CNN when the second CNN is applied to each of the plurality of original frames; extracting a second feature map of an activation of a convolutional layer of the second CNN when the second CNN is applied to a stylized frame corresponding to the original frame; and determining the content loss according to Euclidean distance between the first feature map and second feature map.

According to at least some embodiments, the at least one second loss may include a style loss, and the style loss is obtained by: determining a first Gram matrix according to a first feature map of an activation of a convolutional layer of the second CNN when the second CNN is applied to each of the plurality of original frames; determining a second Gram matrix according to a second feature map of an activation of a convolutional layer of the second CNN when the second CNN is applied to a stylized frame corresponding to the original frame; and determining the style loss according a difference between the first Gram matrix and second Gram matrix.

According to at least some embodiments, determining the style loss according the difference between the first Gram matrix and second Gram matrix may include: determining the style loss according a squared Frobenius norm of the difference between the first Gram matrix and second Gram matrix.

According to at least some embodiments, training the first CNN according to the at least one first loss and the at least one second loss may include: training the first CNN such that a weighted sum of the at least one first loss and the at least one second loss is minimized.

According to at least some embodiments, training the first CNN such that a weighted sum of the at least one first loss and the at least one second loss is minimized may include: training the first CNN based on a method which uses gradient to update network parameters of the first CNN, such that a weighted sum of the at least one first loss and the at least one second loss is minimized.

According to at least some embodiments, the second CNN may be selected from a group comprising a VGG network, InceptionNet, and ResNet.

FIG. 7 illustrates a device for stylizing a video according to at least some embodiments of the present disclosure.

The device includes a styling module 702, configured for stylizing a video by using a first convolutional neural network (CNN). Here, the first CNN has been trained according to at least one first loss which is determined according to a first original frame and second original frame of a plurality of original frames of the video and results of transforming, the second original frame being next to the first original frame, the transforming comprising: transforming each of a plurality of original frames of the video into a stylized frame by using a first CNN for stylizing.

According to at least some embodiments, the at least one first loss comprises a semantic-level temporal loss, and the semantic-level temporal loss is determined according to a first difference between the first output and the second output, the first output is an output of a hidden layer in the first CNN when the first CNN is applied to the first original frame, and the second output is an output of the hidden layer in the first CNN when the first CNN is applied to the second original frame.

According to at least some embodiments, the at least one first loss comprises a contrastive loss, and the contrastive loss is determined according to a second difference between: (a) a difference between the first original frame and a stylized first frame corresponding to the first original frame, and (b) a difference between the second original frame and a stylized second frame corresponding to the second original frame.

According to at least some embodiments, the training the first CNN according to the at least one first loss comprises: training the first CNN according to the at least one first loss and the at least one second loss, wherein the at least one second loss is obtained by: transforming each of the plurality of original frames of the video by using a second CNN, the second CNN having been trained on an ImageNet dataset; transforming each of a plurality of the stylized frames by using the second CNN; and determining the at least one second loss according to an output feature vector of each of the plurality of the original frames at a first layer of the second CNN, and an output feature vector of each of the plurality of the stylized frames at a first layer of the second CNN.

According to at least some embodiments, the at least one second loss comprises a content loss, and the content loss is obtained by: extracting a first feature map of an activation of a convolutional layer of the second CNN when the second CNN is applied to each of the plurality of original frames; extracting a second feature map of an activation of a convolutional layer of the second CNN when the second CNN is applied to a stylized frame corresponding to the original frame; and determining the content loss according to Euclidean distance between the first feature map and second feature map.

According to at least some embodiments, the at least one second loss comprises a style loss, and the style loss is obtained by: determining a first Gram matrix according to a first feature map of an activation of a convolutional layer of the second CNN when the second CNN is applied to each of the plurality of original frames; determining a second Gram matrix according to a second feature map of an activation of a convolutional layer of the second CNN when the second CNN is applied to a stylized frame corresponding to the original frame; and determining the style loss according a difference between the first Gram matrix and second Gram matrix.

According to at least some embodiments, determining the style loss according the difference between the first Gram matrix and second Gram matrix comprises: determining the style loss according a squared Frobenius norm of the difference between the first Gram matrix and second Gram matrix.

According to at least some embodiments, training the first CNN according to the at least one first loss and the at least one second loss comprises: training the first CNN such that a weighted sum of the at least one first loss and the at least one second loss is minimized.

According to at least some embodiments, training the first CNN such that a weighted sum of the at least one first loss and the at least one second loss is minimized comprises: training the first CNN based on a method which uses gradient to update network parameters of the first CNN, such that a weighted sum of the at least one first loss and the at least one second loss is minimized.

According to at least some embodiments, the second CNN is selected from a group comprising a VGG network, InceptionNet, and ResNet.

Some embodiments of the present disclosure will be further described below.

### Network Architecture

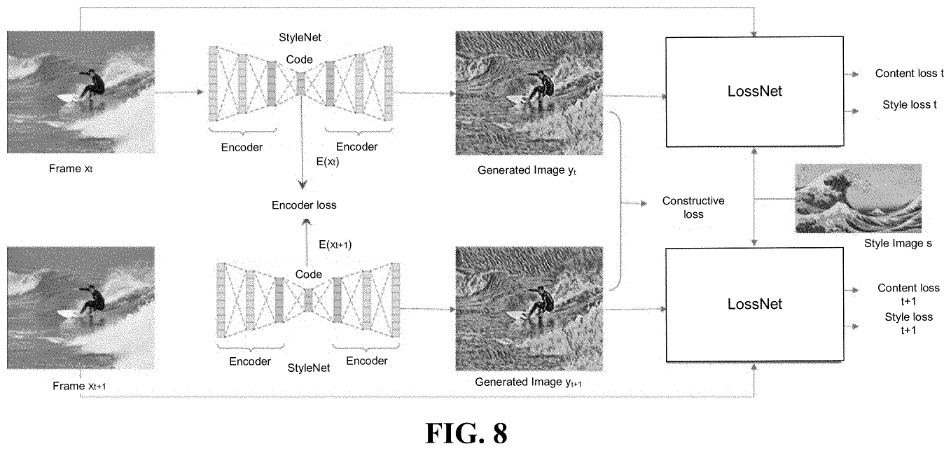

FIG. 8 illustrates the architecture of the proposed Twin Network according to at least some embodiments of the present disclosure. A model of the Twin Network may consist of two parts: StyleNet and LossNet. The video frames are fed into the twin network by pair (e.g., frame t and frame t+1), and the twin network will generate the following losses: content loss t and content loss t+1, style loss t and style loss t+1, encoder loss, and contrastive loss. These losses will be used to update the SyleNet for better video style transfer.

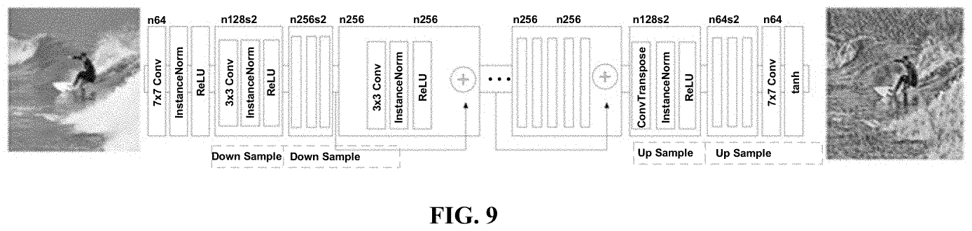

FIG. 9 illustrates more details about the StyleNet. It may be a deep convolutional neural network (CNN) parameterized by weights W. The StyleNet may transform input images x into output images y via the mapping y=fw (x).

Now, the description is made by taking convolutional neural network as an example for fw (x). A convolutional neural network, fw (.), consists of an input and an output layer, as well as multiple hidden layers. The hidden layers of a CNN typically consist of a series of convolutional layers that convolve with a multiplication or other dot product. The activation function is commonly a RELU layer, and is subsequently followed by additional convolutions such as pooling layers, fully connected layers and normalization layers, referred to as hidden layers because their inputs and outputs are masked by the activation function and final convolution. Finally, the network output a transformed image y based on the aforementioned operators.

| Part | Input Shape | Operation | Output Shape |
|---|---|---|---|
| encoder | (h, w, n [symbol] ) | CONV-(C64, K7 × 7, S1 × 1, Pₛₐₘₑ), ReLU, Instance Normal | (h, w, 64) |
| | (h, w, 64) | CONV-(C128, K4 × 4, S2 × 2, Pₛₐₘₑ), ReLU, Instance Normal | $( \frac{h}{2} , \frac{w}{2} , 128 )$ |
| | $( \frac{h}{2} , \frac{w}{2} , 128 )$ | CONV-(C256, K4 × 4, S2 × 2, Pₛₐₘₑ), ReLU, Instance Normal | $( \frac{h}{4} , \frac{w}{4} , 256 )$ |
| bottleneck | $( \frac{h}{8} , \frac{w}{8} , 256 )$ | Residual Block:CONV-(C256, K3 × 3, S1 × 1, Pₛₐₘₑ), ReLU, Instance Normal | $( \frac{h}{8} , \frac{w}{8} , 256 )$ |
| | $( \frac{h}{8} , \frac{w}{8} , 256 )$ | Residual Block:CONV-(C256, K3 × 3, S1 × 1, Pₛₐₘₑ), ReLU, Instance Normal | $( \frac{h}{8} , \frac{w}{8} , 256 )$ |
| | $( \frac{h}{8} , \frac{w}{8} , 256 )$ | Residual Block:CONV-(C256, K3 × 3, S1 × 1, Pₛₐₘₑ), ReLU, Instance Normal | $( \frac{h}{8} , \frac{w}{8} , 256 )$ |
| | $( \frac{h}{8} , \frac{w}{8} , 256 )$ | Residual Block:CONV-(C256, K3 × 3, S1 × 1, Pₛₐₘₑ), ReLU, Instance Normal | $( \frac{h}{8} , \frac{w}{8} , 256 )$ |
| | $( \frac{h}{8} , \frac{w}{8} , 256 )$ | Residual Block:CONV-(C256, K3 × 3, S1 × 1, Pₛₐₘₑ), ReLU, Instance Normal | $( \frac{h}{8} , \frac{w}{8} , 256 )$ |
| | $( \frac{h}{8} , \frac{w}{8} , 256 )$ | Residual Block:CONV-(C256, K3 × 3, S1 × 1, Pₛₐₘₑ), ReLU, Instance Normal | $( \frac{h}{8} , \frac{w}{8} , 256 )$ |
| decoder | $( \frac{h}{4} , \frac{w}{4} , 256 )$ | DECONV-(C128, K4 × 4, S2 × 2, Pₛₐₘₑ), ReLU, Instance Normal | $( \frac{h}{2} , \frac{w}{2} , 128 )$ |
| | $( \frac{h}{2} , \frac{w}{2} , 128 )$ | DECONV-(C64, K4 × 4, S2 × 2, Pₛₐₘₑ), ReLU, Instance Normal | (h, w, 64) |
| | (h, w, 64) | CONCAT | (h, w, 64 + 3) |
| | (h, w, 64 + 3) | CONV-(C(n [symbol] ), K7 × 7, S1 × 1, Pₛₐₘₑ) | (h, w, n [symbol] ) |

[symbol]

indicates data missing or illegible when filed

The loss network, pre-trained on the ImageNet dataset, extracts the features of different inputs and computes the corresponding losses, which are then leveraged for training in the Twin Network.

Note that the loss network can be any kinds of convolutional neural network, such VGG network, InceptionNet, ResNet, and etc. The loss network takes an image as input, and output feature vector of the image at different layer for loss calculation.

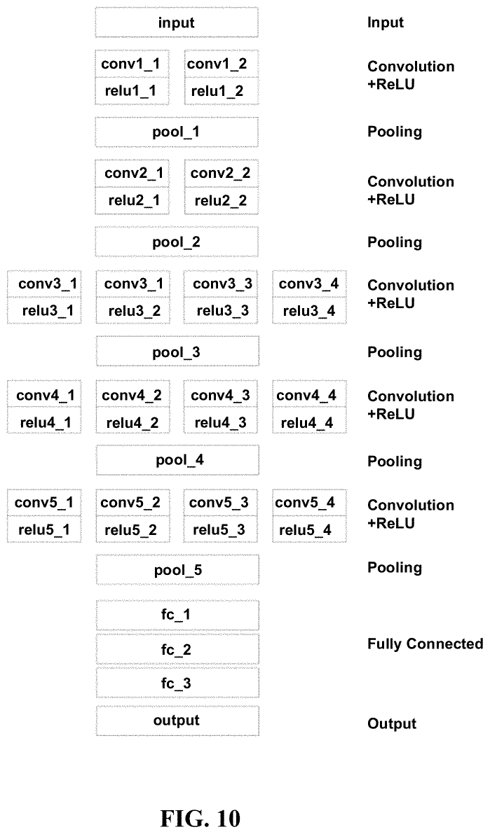

FIG. 10 illustrates a VGG network which is used as a loss network. VGG network is also a CNN network. As described above, in a CNN network, the hidden layers typically consist of a series of convolutional layers that convolve with a multiplication or other dot product. The activation function is commonly a RELU layer, and is subsequently followed by additional convolutions such as pooling layers, fully connected layers and normalization layers, referred to as hidden layers because their inputs and outputs are masked by the activation function and final convolution.

Content loss, style loss, encoder loss, and contrastive loss will be described below. Although the four kinds of losses are disclosed below, it is not necessary use all of the four kinds of losses when training the stylizing net (also called StyleNet herein). Actually, in different scenarios, one of or any combination of the four kinds of losses can be used when training the stylizing net. For example, as discussed above, the first CNN can be trained by using the at least first loss, or the first CNN can be trained by using the at least first loss and the second loss. However, in some embodiments, the first CNN can be trained by using the second loss. The first loss may include a semantic-level temporal loss and/or contrastive loss. The second loss may include a content loss and/or style loss. When the first CNN can be trained by using the second loss, the difference between the original frame and the stylized frame can be minimized, and/or the difference between styles of two frame can be minimized.

### Content Loss

Rather than encouraging the pixels of the output image y=fw (x) to exactly match the pixels of the target image x, we instead encourage the pixels of the output image and the pixels of the target image to have similar feature representations as computed by the loss network φ. Let Φⱼ(.) be the activations of the jth convolutional layer of the VGG network (see Simonyan et al. Very Deep Convolutional Networks for Large-Scale Visual Recognition. ILSVRC-2014). Here, Φⱼ(.) is a feature map of shape Cⱼ×Hⱼ×Wⱼ. Cⱼ represents image channel number, Hⱼ represents image height, and Wⱼ represents image width. The feature reconstruction loss is the (squared, normalized) Euclidean distance between feature representations:

$${L}_{content} = {ℓ}_{feat}^{ϕ , j} ( y , \times ) = \frac{1}{{C}_{j} {H}_{j} {W}_{j}} {‖ {ϕ}_{j} ( y ) - {ϕ}_{j} ( \times ) ‖}_{2}^{2}$$

L_{content} represents content loss, y represents an output frame, i.e., a frame stylized by the StyleNet, x represents target frame, i.e., original frame before the stylizing is performed.

### Style Loss

Gram-matrix may be used to measure which features in the style-layers activate simultaneously for the style-image, and then copy this activation-pattern to the mixed-image.

As above, let φⱼ(x) be the activations at the jth layer of the network φ for the input x, which is a feature map of shape Cⱼ×Hⱼ×Wⱼ. The Gram matrix can be defined as:

$${{G}_{j}^{ϕ} ( x )}_{c , {c}^{′}} = \frac{1}{{C}_{j} {H}_{j} {W}_{j}} {\sum }_{h = 1}^{{H}_{j}} {\sum }_{w = 1}^{{W}_{j}} {{ϕ}_{j} ( x )}_{h , w , c} {{ϕ}_{j} ( x )}_{h , w , {c}^{′}} .$$

100 ⱼ(x)_{h, w, c} represents the activations at the jth layer at axes h, w and channel c of the network φ for the input x, φⱼ(x)_{h, w, c′} represents the activations at the jth layer at axes h, w and channel c′ of the network φ for the input x, Cⱼ represents image channel number, Hⱼ represents image height, and Wⱼ represents image width. G represents Gram matrix.

The style reconstruction loss is then the squared Frobenius norm of the difference between the Gram matrices of the output and target images:

L_{style}= [symbol] _{style}^{φ,j}(y, s)=∥Gⱼ^{φ}(y)−Gⱼ^{φ}(s)∥_{F}².

L_{style} represents style loss, y represents a stylized image, s represents the style image.

As with the content representation, if we had two images whose feature maps at a given layer produced the same Gram matrix we would expect both images to have the same style, but not necessarily the same content. Applying this to early layers in the network would capture some of the finer textures contained within the image whereas applying this to deeper layers would capture more higher-level elements of the image's style.

### Multi-Level Temporal Loss

In this disclosure, a temporal loss is introduced to stabilize the video style transfer. Relevant methods usually try to enforce the temporal consistency at the final output level, which is somewhat difficult since there is less flexibility the StyleNet can do to adjust the outcome. In contrast, if the high-level semantic information is enforced to be synced in earlier network layers, it will be easier and effective for adapting the network to a specific type (e.g., in our case, to generate a stable output frames). We thus propose a multi-level temporal loss design that focuses on temporal coherence at both high-level feature maps and the final stylized output. A two-frame synergic training mechanism is used in the training stage. For each iteration, the network generates feature maps and stylized output of the frame at t and t+1 via the Twin Network, the temporal losses are then generated based on the following mechanism:

### Encoder Loss For Early Stage Enforcement

Relevant method usually tries to enforce the temporal consistency in only the output level (e.g., the last layer of network). However, tuning the result based totally on the output level result is somewhat challenge and has less flexibility to adjust the StyleNet. Here we use the encoder loss to alleviate the problem. The encoder loss penalizes temporal inconsistency on the last level feature map (generated by encoder, as illustrated in FIG. 8) to enforce a high-level semantic similarity between two consecutive frames, which is defined as:

L_{temporal_encoder}=∥E(xₜt)−E(xₜ₊₁)∥²

L_{temporal_encoder} represents encoder loss, E(xₜ) represents output of the middle layer in StyleNet when the StyleNet is applied to frame xₜ, E(xₜ₊₁) represents output of the middle layer in StyleNet when the StyleNet is applied to frame xₜ₊₁. xₜ represents original image in time t, and xₜ₊₁ represents original image in time t+1.

### Contrastive Loss For Output Level Enforcement

To maintain the stability of resulted stylized frames, another temporal loss is used to enforce the consistency between pair of frames at time t and t+1. Tradition loss uses loss like direct temporal loss to minimize the absolute difference between stylized frames (i.e., ∥yₜ−yₜ₊₁∥²) in order to maintain the stability among frames. However, we found that this direct temporal loss cannot achieve good style transfer result due to an irrational assumption that consecutive frames are required to be exactly the same. To avoid this problem, we propose a novel temporal loss called contrastive loss for the output level enforcement, which is defined as:

L_{temporal_output}=∥(xₜ−xₜ₊₁)−(yₜ−yₜ₊₁)∥²

where L_{temporal_output} represents contrastive loss, and xₜ, xₜ₊₁, yₜ, and yₜ₊₁ are the original frame at time t, original frame at time t+1, stylized frame at time t, and stylized frame at time t+1 respectively.

The idea behind contrastive loss is that one should consider the motion changes in the original frames and use them as a guide to update the neural network. For example, if there is a large motion change in the original frames, then we should also expect a relatively large changes between the corresponding stylized frames at time t and t+1. In this case, we should ask the network to output a pair of stylized frames that could be potentially different (instead of blindly enforcing frames t and t+1 to be exactly the same). Otherwise, if only minor or no motion is observed, then the network can generate similar stylized frames.

The contrastive loss smartly achieves this by trying to minimize the difference between the changes of original and stylized frame at time t and t+1. The information can thus correctly guide the StyleNet to generate images depending on the source motion changes. In addition, comparing to the direct temporal loss that is difficult to train, the contrastive loss guarantees a more stable neural network training process and a better converge property.

One advantage of the contrastive loss is that it introduces no extra computation burden to run time.

### Total Loss

The final training objective of the propose method is defined as:

L=Σ_{i∈{t,t+1}}(αL_{content_i}+βL_{style_i})+γLₜₑₘₚₒᵣₐₗLₜₑₘₚₒᵣₐₗ=L_{temporal_encoder}+L_{temporal_output}

where α, β, and γ are the weighting parameters.

Stochastic gradient descent may be used to minimize the loss function L to achieve the stable video style transfer. Stochastic gradient descent attempts to find the global minimum by adjusting the configuration of the network after each training point. Instead of decreasing the error, or finding the gradient, for the entire data set, this method merely decreases the error by approximating the gradient for a randomly selected batch (which may be as small as single training sample). In practice, the random selection is achieved by randomly shuffling the dataset and working through batches in a stepwise fashion. In addition to Stochastic gradient descent, some other optimizer can also be used to train the network, such as RMSProp and Adam, where they are all based on a similar manner by using gradient to update the network parameters.

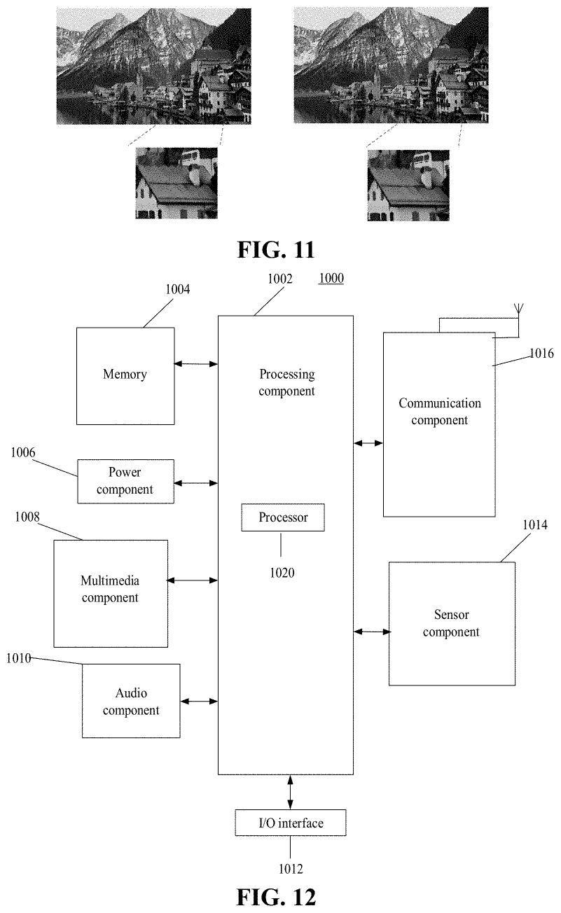

FIG. 11 illustrates the style transfer result from the proposed Twin Network. As can be seen, the stylized frames are much more consistent comparing to the relevant method, which prove the effectiveness of the proposed Twin Network and contrastive loss.

For example, the electronic device may be a smart phone, a computer, tablet equipment, wearable equipment and the like.

Referring to FIG. 12 the electronic device may include one or more of the following components: a processing component 1002, a memory 1004, a power component 1006, a multimedia component 1008, an audio component 1010, an Input/Output (I/O) interface 1012, a sensor component 1014, and a communication component 1016.

The processing component 1002 typically controls overall operations of the electronic device, such as the operations associated with display, telephone calls, data communications, camera operations, and recording operations. The processing component 1002 may include one or more processors 1020 to execute instructions to perform all or part of the steps in the abovementioned method. Moreover, the processing component 1002 may include one or more modules which facilitate interaction between the processing component 1002 and the other components. For instance, the processing component 1002 may include a multimedia module to facilitate interaction between the multimedia component 1008 and the processing component 1002.

The memory 1004 is configured to store various types of data to support the operation of the electronic device. Examples of such data include instructions for any application programs or methods operated on the electronic device, contact data, phonebook data, messages, pictures, video, etc. The memory 1004 may be implemented by any type of volatile or non-volatile memory devices, or a combination thereof, such as a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, and a magnetic or optical disk.

The power component 1006 provides power for various components of the electronic device. The power component 1006 may include a power management system, one or more power supplies, and other components associated with generation, management and distribution of power for the electronic device.

The multimedia component 1008 may include a screen providing an output interface between the electronic device and a user. In some embodiments, the screen may include a Liquid Crystal Display (LCD) and a Touch Panel (TP). If the screen may include the TP, the screen may be implemented as a touch screen to receive an input signal from the user. The TP may include one or more touch sensors to sense touches, swipes and gestures on the TP. The touch sensors may not only sense a boundary of a touch or swipe action but also detect a duration and pressure associated with the touch or swipe action. In some embodiments, the multimedia component 1008 may include a front camera and/or a rear camera. The front camera and/or the rear camera may receive external multimedia data when the electronic device is in an operation mode, such as a photographing mode or a video mode. Each of the front camera and the rear camera may be a fixed optical lens system or have focusing and optical zooming capabilities.

The audio component 1010 is configured to output and/or input an audio signal. For example, the audio component 1010 may include a Microphone (MIC), and the MIC is configured to receive an external audio signal when the electronic device is in the operation mode, such as a call mode, a recording mode and a voice recognition mode. The received audio signal may further be stored in the memory 1004 or sent through the communication component 1016. In some embodiments, the audio component 1010 further may include a speaker configured to output the audio signal.

The I/O interface 1012 provides an interface between the processing component 1002 and a peripheral interface module, and the peripheral interface module may be a keyboard, a click wheel, a button and the like. The button may include, but not limited to: a home button, a volume button, a starting button and a locking button.

The sensor component 1014 may include one or more sensors configured to provide status assessment in various aspects for the electronic device. For instance, the sensor component 1014 may detect an on/off status of the electronic device and relative positioning of components, such as a display and small keyboard of the electronic device, and the sensor component 1014 may further detect a change in a position of the electronic device or a component of the electronic device, presence or absence of contact between the user and the electronic device, orientation or acceleration/deceleration of the electronic device and a change in temperature of the electronic device. The sensor component 1014 may include a proximity sensor configured to detect presence of an object nearby without any physical contact. The sensor component 1014 may also include a light sensor, such as a Complementary Metal Oxide Semiconductor (CMOS) or Charge Coupled Device (CCD) image sensor, configured for use in an imaging application. In some embodiments, the sensor component 1014 may also include an acceleration sensor, a gyroscope sensor, a magnetic sensor, a pressure sensor or a temperature sensor.

The communication component 1016 is configured to facilitate wired or wireless communication between the electronic device and other equipment. The electronic device may access a communication-standard-based wireless network, such as a WIFI network, a 2nd-Generation (2G) or 3G network or a combination thereof. In an exemplary embodiment, the communication component 1016 receives a broadcast signal or broadcast associated information from an external broadcast management system through a broadcast channel. In an exemplary embodiment, the communication component 1016 further may include a Near Field Communication (NFC) module to facilitate short-range communication. For example, the NFC module may be implemented on the basis of a Radio Frequency Identification (RFID) technology, an Infrared Data Association (IrDA) technology, an Ultra-WideBand (UWB) technology, a BT technology and another technology.

In an exemplary embodiment, the electronic device may be implemented by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), controllers, micro-controllers, microprocessors or other electronic components, and is configured to execute the abovementioned method.

In an exemplary embodiment, there is also provided a non-transitory computer-readable storage medium including an instruction, such as a memory including an instruction, and the instruction may be executed by a processor of the electronic device to implement the abovementioned method. For example, the non-transitory computer-readable storage medium may be a ROM, a Random Access Memory (RAM), a Compact Disc Read-Only Memory (CD-ROM), a magnetic tape, a floppy disc, an optical data storage device and the like.

According to a non-transitory computer-readable storage medium, when an instruction in the storage medium is executed by a processor of electronic device to enable the electronic device to execute an information sharing method.

Other implementation solutions of the present disclosure will be apparent to those skilled in the art from consideration of the specification and practice of the present disclosure. This application is intended to cover any variations, uses, or adaptations of the present disclosure following the general principles thereof and including such departures from the present disclosure as come within known or customary practice in the art. It is intended that the specification and examples be considered as exemplary only, with a true scope and spirit of the present disclosure being indicated by the following claims.

It will be appreciated that the present disclosure is not limited to the exact construction that has been described above and illustrated in the accompanying drawings, and that various modifications and changes may be made without departing from the scope thereof. It is intended that the scope of the present disclosure only be limited by the appended claims.

1. A method for training a convolutional neural network (CNN) for stylizing a video, comprising:
transforming each of a plurality of original frames of the video into a stylized frame by using a first CNN for stylizing;
determining at least one first loss according to a first original frame and second original frame of the plurality of original frames and results of the transforming, the second original frame being next to the first original frame; and
training the first CNN according to the at least one first loss.

2. The method of claim 1, wherein the at least one first loss comprises a semantic-level temporal loss, and the determining at least one first loss comprises:
extracting a first output of a hidden layer in the first CNN when the first CNN is applied to the first original frame, and extracting a second output of the hidden layer in the first CNN when the first CNN is applied to the second original frame; and
determining a semantic-level temporal loss according to a first difference between the first output and the second output.

3. The method of claim 1, wherein the at least one first loss comprises a contrastive loss, and the determining at least one first loss comprises:
determining a contrastive loss according to a second difference between: (a) a difference between the first original frame and a stylized first frame corresponding to the first original frame, and (b) a difference between the second original frame and a stylized second frame corresponding to the second original frame.

4. The method of claim 1, further comprising:
transforming each of the plurality of original frames of the video by using a second CNN, the second CNN having been trained on an ImageNet dataset;
transforming each of a plurality of the stylized frames by using the second CNN;
determining at least one second loss according to an output feature vector of each of the plurality of the original frames at a first layer of the second CNN, and an output feature vector of each of the plurality of the stylized frames at a first layer of the second CNN,
wherein training the first CNN according to the at least one first loss comprises training the first CNN according to the at least one first loss and the at least one second loss.

5. The method of claim 4, wherein the at least one second loss comprises a content loss, and the method further comprises:
extracting a first feature map of an activation of a convolutional layer of the second CNN when the second CNN is applied to each of the plurality of original frames;
extracting a second feature map of an activation of a convolutional layer of the second CNN when the second CNN is applied to a stylized frame corresponding to the original frame; and
determining the content loss according to Euclidean distance between the first feature map and second feature map.

6. The method of claim 4, wherein the at least one second loss comprises a style loss, and the method further comprises:
determining a first Gram matrix according to a first feature map of an activation of a convolutional layer of the second CNN when the second CNN is applied to each of the plurality of original frames;
determining a second Gram matrix according to a second feature map of an activation of a convolutional layer of the second CNN when the second CNN is applied to a stylized frame corresponding to the original frame; and
determining the style loss according a difference between the first Gram matrix and second Gram matrix.

7. The method of claim 6, wherein determining the style loss according the difference between the first Gram matrix and second Gram matrix comprises:
determining the style loss according a squared Frobenius norm of the difference between the first Gram matrix and second Gram matrix.

8. The method of claim 6, wherein training the first CNN according to the at least one first loss and the at least one second loss comprises:
training the first CNN such that a weighted sum of the at least one first loss and the at least one second loss is minimized.

9. The method of claim 8, wherein training the first CNN such that a weighted sum of the at least one first loss and the at least one second loss is minimized comprises:
training the first CNN based on a method which uses gradient to update network parameters of the first CNN, such that a weighted sum of the at least one first loss and the at least one second loss is minimized.

10. The method of claim 4, wherein the second CNN is selected from a group comprising a VGG network, InceptionNet, and ResNet.

11. A method for stylizing a video, comprising:
stylizing a video by using a first convolutional neural network (CNN);
wherein the first CNN has been trained according to at least one first loss which is determined according to a first original frame and second original frame of a plurality of original frames of the video and results of transforming, the second original frame being next to the first original frame, the transforming comprising: transforming each of a plurality of original frames of the video into a stylized frame by using a first CNN for stylizing.

12. The method of claim 11, wherein the at least one first loss comprises a semantic-level temporal loss, and the semantic-level temporal loss is determined according to a first difference between a first output and a second output, the first output is an output of a hidden layer in the first CNN when the first CNN is applied to the first original frame, and the second output is an output of the hidden layer in the first CNN when the first CNN is applied to the second original frame.

13. The method of claim 11, wherein the at least one first loss comprises a contrastive loss, and the contrastive loss is determined according to a second difference between: (a) a difference between the first original frame and a stylized first frame corresponding to the first original frame, and (b) a difference between the second original frame and a stylized second frame corresponding to the second original frame.

14. The method of claim 11, wherein the training the first CNN according to the at least one first loss comprises training the first CNN according to the at least one first loss and the at least one second loss;
wherein the at least one second loss is obtained by:
transforming each of the plurality of original frames of the video by using a second CNN, the second CNN having been trained on an ImageNet dataset;
transforming each of a plurality of the stylized frames by using the second CNN; and
determining the at least one second loss according to an output feature vector of each of the plurality of the original frames at a first layer of the second CNN, and an output feature vector of each of the plurality of the stylized frames at a first layer of the second CNN.

15. The method of claim 14, wherein the at least one second loss comprises a content loss, and the content loss is obtained by:
extracting a first feature map of an activation of a convolutional layer of the second CNN when the second CNN is applied to each of the plurality of original frames;
extracting a second feature map of an activation of a convolutional layer of the second CNN when the second CNN is applied to a stylized frame corresponding to the original frame; and
determining the content loss according to Euclidean distance between the first feature map and second feature map.

16. The method of claim 14, wherein the at least one second loss comprises a style loss, and the style loss is obtained by:
determining a first Gram matrix according to a first feature map of an activation of a convolutional layer of the second CNN when the second CNN is applied to each of the plurality of original frames;
determining a second Gram matrix according to a second feature map of an activation of a convolutional layer of the second CNN when the second CNN is applied to a stylized frame corresponding to the original frame; and
determining the style loss according a difference between the first Gram matrix and second Gram matrix.

17. The method of claim 16, wherein determining the style loss according the difference between the first Gram matrix and second Gram matrix comprises:
determining the style loss according a squared Frobenius norm of the difference between the first Gram matrix and second Gram matrix.

18. The method of claim 16, wherein training the first CNN according to the at least one first loss and the at least one second loss comprises:
training the first CNN such that a weighted sum of the at least one first loss and the at least one second loss is minimized.

19. The method of claim 18, wherein training the first CNN such that a weighted sum of the at least one first loss and the at least one second loss is minimized comprises:
training the first CNN based on a method which uses gradient to update network parameters of the first CNN, such that a weighted sum of the at least one first loss and the at least one second loss is minimized.

20. A device for stylizing a video, comprising:
a memory for storing instructions; and
at least one processor configured to execute the instructions to perform operations of:
stylizing a video by using a first convolutional neural network (CNN);
wherein the first CNN has been trained according to at least one first loss which is determined according to a first original frame and second original frame of a plurality of original frames of the video and results of transforming, the second original frame being next to the first original frame, the transforming comprising: transforming each of a plurality of original frames of the video into a stylized frame by using a first CNN for stylizing.
